(19) United States
(12) Patent Application Publication
(10) Pub. No.: US 2024/0378873 A1
(43) Pub. Date: Nov. 14, 2024

(54) METHOD, APPARATUS, ELECTRONIC DEVICE AND MEDIUM FOR PROCESSING MULTI-MODAL DATA

(71) Applicant: BEIJING YOUZHUJU NETWORK TECHNOLOGY CO., LTD., Beijing (CN)

(72) Inventors: Longteng GUO, Beijing (CN); Junyi CHEN, Beijing (CN); Jia SUN, Beijing (CN); Zehuan YUAN, Beijing (CN)

(21) Appl. No.: 18/658,548

(22) Filed: May 8, 2024

(30) Foreign Application Priority Data
May 8, 2023 (CN) 202310511915.8

(51) Int. Cl. G06V 10/80; G06F 40/10; G06V 10/26; G06V 10/774; G06V 10/82

(52) U.S. Cl. CPC G06V 10/806; G06F 40/10; G06V 10/26; G06V 10/774; G06V 10/82

(57) ABSTRACT

Embodiments of the present disclosure relate to methods, apparatuses, electronic devices, and media for processing multi-modal data. The method comprises dividing a source image into a set of source pixel blocks and generating a sequence of masked source pixel blocks by masking one or more source pixel blocks in the set of source pixel blocks. The method further comprises generating one or more target pixel blocks corresponding to the one or more source pixel blocks based on the sequence of masked source pixel blocks and a source text corresponding to the source image. The method further comprises generating a multi-modal model based on the one or more source pixel blocks and the one or more target pixel blocks. The method can effectively reduce the training cost, reduce the complexity of training the multi-modal model, and improve the stability and accuracy of the model.

### CROSS-REFERENCE TO RELATED APPLICATION(S)

This application claims priority to Chinese Application No. 202310511915.8 filed on May 8, 2023, the disclosures of which are incorporated herein by reference in their entities.

### FIELD

The present disclosure relates generally to the field of machine learning, and more particularly to a method, apparatus, electronic device, and medium for processing multi-modal data.

### BACKGROUND

Multi-modal data refers to a dataset made up of data of multiple modalities, and typically comprises different types of information, such as texts, images, audios, videos, etc. Multi-modal data can facilitate a more comprehensive understanding and analysis of various things in the real world. In the field of machine learning, researchers process these data by building a multi-modal model to achieve tasks such as more accurate prediction, classification and generation.

For example, in Natural Language Processing (NLP) and Computer Vision (CV) tasks, the multi-modal model can process text and image information simultaneously, thereby achieving better performance in tasks such as scene understanding, automatic image annotation, image description generation, and the like. The multi-mode model obtained by training on large-scale unlabeled data can be quickly adapted and applied to various different downstream tasks, and has a large number of demands.

### SUMMARY

Embodiments of the present disclosure provide a method, apparatus, electronic device, and medium for processing multi-modal data.

In a first aspect of the present disclosure, there is provided a method for processing multi-modal data. The method comprises dividing a source image into a set of source pixel blocks, each pixel block in the set of source pixel blocks comprising a plurality of pixels. The method further comprises generating a masked source pixel block sequence by masking one or more source pixel blocks of the set of source pixel blocks. The method further comprises generating one or more target pixel blocks corresponding to the one or more source pixel blocks based on the masked source pixel block sequence and a source text corresponding to the source image. In addition, the method further comprises generating a multi-modal model based on the one or more source pixel blocks and the one or more target pixel blocks.

In a second aspect of the present disclosure, there is provided an apparatus for processing multi-modal data. The apparatus comprises a pixel block dividing module configured to divide a source image into a set of source pixel blocks, each pixel block in the set of source pixel blocks comprising a plurality of pixels. The apparatus further comprises a pixel block masking module configured to mask one or more source pixel blocks of the set of source pixel blocks to generate a masked source pixel block sequence. The apparatus further comprises a pixel block generating module configured to generate one or more target pixel blocks corresponding to the one or more source pixel blocks based on the masked source pixel block sequence and a source text corresponding to the source image. In addition, the apparatus further comprises a multi-modal model generating module configured to generate a multi-modal model based on the one or more source pixel blocks and the one or more target pixel blocks.

In a third aspect of the present disclosure, there is provided an electronic device. The electronic device comprises one or more processor; and a storage device for storing one or more programs which when executed by the one or more processors, cause the one or more processor to implement the method for processing multi-modal data. The method comprises dividing a source image into a set of source pixel blocks, each pixel block in the set of source pixel blocks comprising a plurality of pixels. The method further comprises generating a masked source pixel block sequence by masking one or more source pixel blocks of the set of source pixel blocks. The method further comprises generating one or more target pixel blocks corresponding to the one or more source pixel blocks based on the masked source pixel block sequence and a source text corresponding to the source image. In addition, the method further comprises generating a multi-modal model based on the one or more source pixel blocks and the one or more target pixel blocks.

In a fourth aspect of the present disclosure, there is provided a computer readable storage medium in which is stored a computer program which when executed by a processor, implements the method for processing multi-modal data. The method comprises dividing a source image into a set of source pixel blocks, each pixel block in the set of source pixel blocks comprising a plurality of pixels. The method further comprises generating a masked source pixel block sequence by masking one or more source pixel blocks of the set of source pixel blocks. The method further comprises generating one or more target pixel blocks corresponding to the one or more source pixel blocks based on the masked source pixel block sequence and a source text corresponding to the source image. In addition, the method further comprises generating a multi-modal model based on the one or more source pixel blocks and the one or more target pixel blocks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of embodiments of the present disclosure will become more apparent through the following detailed depictions with reference to the following figures. In the figures, like or similar reference numerals denote like or similar elements, wherein:

FIG. 1 illustrates a schematic diagram of an example environment in which various embodiments of the present disclosure may be implemented;

FIG. 2 illustrates a flow chart of a method for processing multi-modal data in accordance with some embodiments of the present disclosure;

FIG. 3 illustrates a schematic diagram of a process of training a multi-modal model by masking images, according to some embodiments of the present disclosure;

FIG. 4 illustrates a schematic diagram of a process of training a multi-modal model by masking a text, according to some embodiments of the present disclosure;

FIG. 5A illustrates a schematic diagram of a structure of a multi-modal model according to some embodiments of the present disclosure;

FIG. 5B illustrates a schematic diagram of a process of generating an embedding of pixel block sequence and an embedding of word sequence, according to some embodiments of the present disclosure;

FIG. 6 illustrates a schematic diagram of a structure of a routing network used in the structure of a multi-modal model, according to some embodiments of the present disclosure;

FIG. 7 illustrates a schematic diagram of a process of using a multi-modal model in an inference phase according to some embodiments of the present disclosure;

FIG. 8 illustrates a block diagram of an apparatus for processing multi-modal data according to some embodiments of the present disclosure; and

FIG. 9 illustrates a block diagram of a device capable of implementing various embodiments of the present disclosure.

### DETAILED DESCRIPTION

It will be appreciated that all user-related data involved by the present scheme should be obtained and used after the user's authorization. This means that in the present scheme, if personal information of the user needs to be used, before these data are obtained, explicit consent and authorization of the user are required, otherwise no relevant data collection and use will be performed. It should also be understood that when implementing the technical scheme, related laws and regulations should be strictly complied with in the process of collecting, using and storing data, and necessary technologies and measures should be taken to ensure the data security of the user and ensure the safe use of the data.

Embodiments of the present disclosure will be described in more detail below with reference to the accompanying drawings. While certain embodiments of the present disclosure have been shown in the accompanying drawings, it is to be understood that the present disclosure may be embodied in various forms and should not be construed as being limited to the embodiments set forth herein, and instead, these embodiments are provided to provide a more thorough and complete understanding of the present disclosure. It should be understood that the drawings and embodiments of the present disclosure are for illustration purposes only and are not intended to limit the scope of the present disclosure.

In the depictions of the embodiments of the present disclosure, the term “include” and its like should be understood to be open-ended, i.e., “include but not limited to”. The term “based on” should be understood as “based at least in part on. The term “one embodiment” or “the embodiment” should be understood as “at least one embodiment”. The terms “first”, “second” and the like, may refer to different or the same object unless explicitly stated otherwise. Other explicit and implicit definitions are also possibly included in the following text.

Embodiments of the present disclosure provide a method, apparatus, electronic device, and medium for processing multi-modal data, enabling the training of a multi-modal model with less training data, reducing the complexity of training the multi-modal model and improving the stability and accuracy of the model.

As described above, the multi-modal model is capable of processing and understanding data of multiple modalities, such as texts, images, audios, and videos, etc. These models are trained during a pre-training phase using a large amount of multi-modal data to capture shared information and inherent correlations between different modalities. Through training, the multi-modal model may learn richer and deeper knowledge, thereby improving the performance of the model on various tasks. These models may also migrate knowledge learned on one modality to another modality, thereby achieving better generalization and reasoning capabilities. In addition, the multi-modal model may be applied to various cross-modal tasks, such as text-to-image generation, image-to-text generation, video understanding, multi-modal questioning and answering, and the like.

Pre-training refers to training a general-purpose model using a large amount of unlabeled data over a certain task to allow it to learn some general features or knowledge. Then, the general-purpose model is used as an initialization model of a downstream task, and fine tuning or migration learning is carried out on the model by using the labelled data, so that the model is suitable for the use situation of the downstream task. A main advantage of using a pre-trained model is that it may significantly improve the performance of downstream tasks while also saving a lot of training time and computational resources. The pre-trained model generally has better initial performance than a random initialization model and has learned some general features or knowledge so that the training process converges faster and achieves a better result when fine-tuning is performed in the downstream task.

During the pre-training of the multi-modal model, some conventional schemes use Image Text Contrast (ITC) and Image Text Matching (ITM) techniques to learn the relationship between visual content and language content. However, these schemes consume a lot of computational resources and rely on a lot of training data during one iteration of the training. In other conventional schemes, to model image data, a visual tokenizer needs to be trained to convert pixels in an image into a visual token and then the multi-modal model is trained using the visual token. However, these schemes are very strict with the accuracy of the generated visual token. In other words, if the accuracy of the pre-trained visual tokenizer cannot be ensured, the accuracy of the trained multi-modal model cannot be ensured as well.

To this end, embodiments of the present disclosure propose a scheme for processing multi-modal data. According to the scheme, the multi-modal model is trained using an image and a text corresponding to the image (e.g., a descriptive text about the image) as training data. In the scheme, the image is divided into several pixel blocks, each pixel block containing a plurality of pixels. A portion of these pixel blocks are then masked to generate a masked pixel block sequence. In the scheme, the multi-modal model is used to generate target pixel blocks corresponding to the masked pixel blocks based on the masked pixel block sequence and the descriptive text of the image. The task of the multi-modal model is to bring the generated target pixel blocks close to the corresponding original pixel blocks before being masked. Thus, in the scheme, the multi-modal model is trained based on differences between the generated target pixel blocks and the corresponding original pixel blocks. In this way, the scheme provided by the embodiments of the present disclosure may efficiently utilize the existing training data by masking different pixel blocks in the same image, so that the multi-modal model may be trained by using less training data, and the training cost is reduced. In addition, the scheme avoids training an additional visual tokenizer by comparing differences among pixel blocks, thereby reducing the complexity in training the multi-mode model and improving the stability and accuracy of the model.

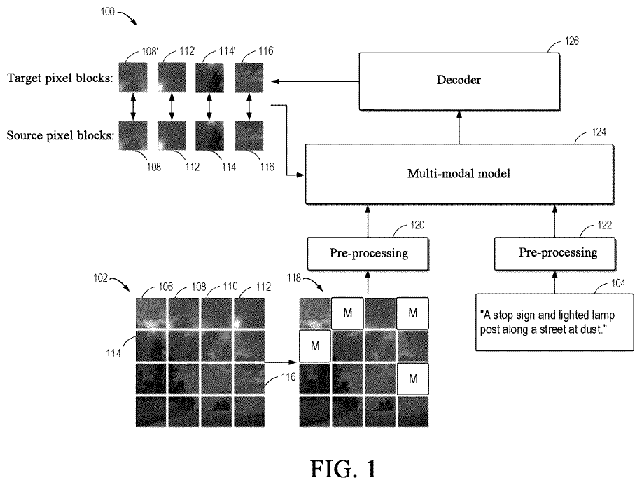

FIG. 1 illustrates a schematic diagram of an example environment 100 in which various embodiments of the present disclosure may be implemented. In the example shown in FIG. 1, the environment 100 comprises an image 102 and a text 104 describing the content of the image 102. The image 102 shows a dim sky, a street, a stop sign and a lighted street lamp on both sides of the street. The text 104 is an English sentence, i.e., “a stop sign and lighted lamp post along a street at dust”. In the example shown in FIG. 1, the image 102 is divided into 4 rows and 4 columns totally 16 pixel blocks, e.g., pixel blocks 106, 108, 110, 112, 114, 116, etc. These pixel blocks are obtained from the original image and are therefore referred to as source pixel blocks, and each pixel block comprises a plurality of pixels, for example 120×200 pixels etc. In the environment 100, a portion of these pixel blocks may be masked with any predetermined mask image (represented by pixel blocks marked with the letter “M” in FIG. 1), e.g., pixel blocks 108, 112, 114, and 116 are masked in the example of FIG. 1, thereby generating a masked pixel block sequence 118. To more clearly show which pixel blocks in the original image are masked, the masked pixel block sequence 118 is still displayed in a two-dimensional form of 4 rows and 4 columns, but it may also be represented as a one-dimensional ordered pixel block sequence.

As shown in FIG. 1, the environment 100 includes a multi-modal model 124. Through preprocessing 120, the masked pixel block sequence 118 is processed into a form of embedding and is input to the multi-modal model 124. At the same time, the text 104 is also processed into a form of embedding and is input to the multi-modal model 124 by preprocessing 122. Embedding (also referred to as an embedding vector) is a continuous vector representation that results from the conversion of discrete features. When discrete features (e.g., color, words etc.) in the fields such as images and texts are processed, these discrete features may be converted into a form of embedding for use in subsequent algorithms. The multi-modal model 124 then outputs multi-modal features based on the masked pixel block sequence 118 and text 104 in the form of embedding. The output multi-modal features comprise image features and text features. Then, in the example of FIG. 1, a decoder 126 may be used to generate a target pixel block for each masked pixel block based on the output multi-modal features. In other words, based on the output multi-modal features, the decoder 126 may reconstruct the content of the masked pixel blocks. For example, the decoder 126 may output target pixel blocks 108′, 112′, 114′, and 116′, wherein the target pixel block 108′ is a reconstruction of the masked source pixel block 108 based on an image feature portion of the multi-modal feature, the target pixel block 112′ is a reconstruction of the masked source pixel block 112, the target pixel block 114′ is a reconstruction of the masked source pixel block 114, and target pixel block 116′ is a reconstruction of the masked source pixel block 116. Then, the target pixel blocks and the source pixel blocks may be compared to obtain a difference, and the difference is back-propagated to the multi-modal model 124 to optimize various parameters in the multi-modal model 124. The training of the multi-modal model 124 is completed through a number of back-propagation and optimization.

It should be appreciated that the image, text, division method, and masking method shown in FIG. 1 are given by way of example only, and embodiments of the present disclosure should not be limited to any particular image, text, division method, and masking method. For example, the image 108 may be an image in any size and number, the text 104 may be a text in any language, and with any length and any content, the image 102 may be divided into any number of pixel blocks, each pixel block may include any number of pixels, and any number of pixel blocks in the pixel blocks may be replaced with any predetermined mask images.

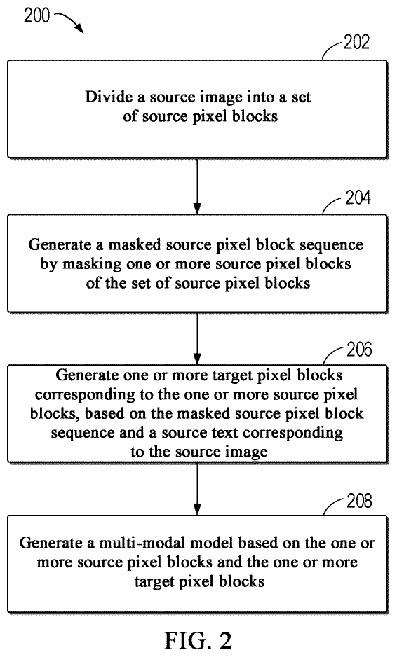

FIG. 2 illustrates a flow chart of a method 200 for processing multi-modal data according to some embodiments of the present disclosure. As shown in FIG. 2, at block 202, by the method 200, a source image is divided into a set of source pixel blocks. For example, in the example of FIG. 1, the image 102 may be divided into 16 pixel blocks (e.g., pixel blocks 106, 108, 110, 112, 114, 116, etc.) in 4 rows and 4 columns, wherein each pixel block comprises a plurality of pixels.

At block 204, by the method 200, a masked source pixel block sequence is generated by masking one or more source pixel blocks in the set of source pixel blocks. For example, in the example of FIG. 1, any predetermined pixel blocks may be used as mask pixel blocks (represented by pixel blocks marked with the letter “M” in FIG. 1) to mask a portion of these pixel blocks, e.g., pixel blocks 108, 112, 114, and 116 are masked in the example of FIG. 1, to generate the masked pixel block sequence 118.

At block 206, by the method 200, one or more target pixel blocks corresponding to one or more source pixel blocks are generated based on the masked source pixel block sequence and a source text corresponding to the source image. For example, in the example of FIG. 1, the masked source pixel block sequence 118 and the text 104 may each be pre-processed into a form of embedding acceptable by the multi-modal model 124, and then input to the multi-modal model 124. The multi-modal model 124 may output multi-modal features based on the masked source pixel block sequence 118 and text 104 in the form of embedding. Then, image feature portions of the output multi-modal features may be decoded using the decoder 126 to generate the target pixel blocks 108′, 112′, 114′ and 116′. The target pixel block 108′ is a reconstruction of the masked source pixel block 108 based on the image feature portions of the output multi-modal features, the target pixel block 112′ is a reconstruction of the masked source pixel block 112, the target pixel block 114′ is a reconstruction of the masked source pixel block 114, and the target pixel block 116′ is a reconstruction of the masked source pixel block 116.

At block 208, by the method 200, a multi-modal model is generated based on the one or more source pixel blocks and the one or more target pixel blocks. For example, in the example of FIG. 1, a loss function (also referred to as a first loss function) may be constructed based on the reconstructed target pixel blocks and the original source pixel blocks to calculate the current loss. Then, this loss may be back-propagated to the multi-modal model 124 to optimize various parameters in the multi-modal model 124. When the loss is less than a certain threshold, training of the multi-modal model 124 may be completed. The trained multi-modal model 124 may be used for downstream tasks, in particular, the downstream tasks use the multi-modal model 124 to process multi-modal data including image-text pairs and generate multi-modal features that fuse knowledge and features of the same thing in the content of different modalities (images and texts).

In this way, by masking different pixel blocks in the same image, the method 200 may use the current training data more efficiently, thereby enabling the training of the multi-modal model with less training data, and reducing training costs. In addition, the method 200 avoids training additional visual tokenizers by comparing the pixel blocks to obtain a difference, thereby reducing the complexity of training the multi-modal model and improving the stability and accuracy of the model.

When the images in the training data have a large size, the multi-modal model needs to consume significant computational resources. In some embodiments, to reduce the requirements for the computing capability and reduce the consumption of computational resources, when the masked source pixel block sequence is pre-processed, the masked source pixel blocks may be removed from the masked source pixel block sequence, thereby generating a reserved pixel block sequence. Then, an embedding of reserved pixel block sequence may be generated based on the reversed pixel block sequence, and the multi-modal model may generate multi-modal features based on the reserved pixel block sequence. After the multi-modal features are generated, the features of the masked pixel block may be inserted back to corresponding positions in the multi-modal features, and then the target pixel blocks may be generated based on the inserted multi-modal features. The scheme provided by the embodiments may reduce an effective area in the image which needs to be processed by the multi-mode model, thereby reducing the computation amount and the consumption of computational resources and reducing the requirements for the computing capability.

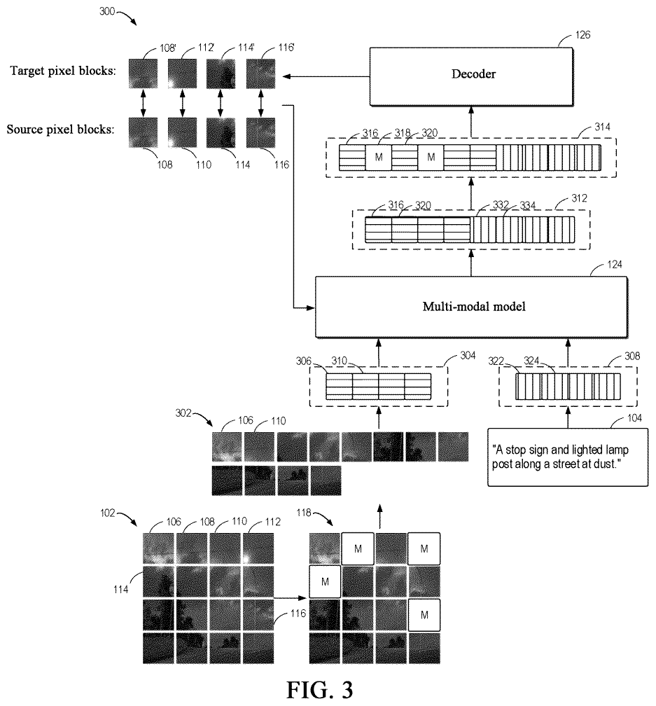

FIG. 3 illustrates a schematic diagram of a process 300 for training a multi-modal model by masking images, according to some embodiments of the present disclosure. As shown in FIG. 3, in the process 300, the image 102 is divided into a set of pixel blocks (pixel blocks 106, 108, 110, 112, 114, 116, etc.). In the process 300, predetermined mask pixel blocks (represented by pixel blocks marked with the letter “M” in FIG. 3) are used to randomly mask a number of pixel blocks (e.g., pixel blocks 108, 112, 114, and 116) of the plurality of pixel blocks to generate the masked pixel block sequence 118. In the embodiment shown in FIG. 3, in the process 300, the four masked pixel blocks are removed from the masked pixel block sequence 118, and the remaining pixel blocks in the sequence are reserved to thereby obtain a reserved pixel block sequence 302 including the remaining 12 pixel blocks. For example, since the masked pixel blocks are removed from the sequence 108, the pixel block 110 in the reserved pixel block sequence 302 becomes located after the pixel block 106.

In the example shown in FIG. 3, in the process 300, the embedding of reserved pixel block sequence 304 is generated based on the reserved pixel block sequence 302. For example, in the process 300 techniques such as a self-encoder, a convolutional neural network, etc. may be used to generate a corresponding pixel block embedding for each pixel block in the embedding of reserved pixel block sequence 304, respectively. For example, a pixel block embedding 306 is an embedding representation of the pixel block 106, and a pixel block embedding 310 is an embedding representation of the pixel block 110. The embedding of reserved pixel block sequence 304 is an ordered embedding sequence consisting of all such pixel block embeddings. The embedding of reserved pixel block sequence 304 comprises 12 pixel block embeddings corresponding to 12 reserved pixel blocks. However, only 4 pixel block embeddings are shown in FIG. 3 for the sake of brevity.

On the other hand, in the process 300, an embedding of word sequence 308 is generated based on the text 104. For example, in the process 300, a technique such as a transformer may be employed to generate a corresponding word embedding for each word in the text 104. For example, a word embedding 322 is an embedding representation of the word “A”, and a word embedding 324 is an embedding representation of the word “stop”. The embedding of word sequence 308 include 12 word embeddings corresponding to 12 words (also referred to as source words) in the text 104. However, only 4 word embeddings are shown in FIG. 3 for the sake of brevity.

As shown in FIG. 3, in the process 300, the embedding of reserved pixel block sequence 304 and the embedding of word sequence 308 are input into multi-modal model 124, so that the multi-modal model can learn knowledge and features shared between pixel block embedding and word embedding, and then a multi-modal feature 312 (also referred to as a first multi-modal feature) is output. In the example shown in FIG. 3, the multi-modal feature 312 comprises an image feature portion and a text feature portion. The image feature portion comprises 12 pixel block features corresponding to 12 pixel block embeddings in the embedding of reserved pixel block sequence 304. For example, a pixel block feature 316 corresponds to a pixel block embedding 306 of the pixel block 106, and image feature 320 corresponds to a pixel block embedding 310 of the pixel block 110. The text feature portion comprises 12 word features, which correspond to 12 word embeddings in the embedding of word sequence 308. For example, a word feature 332 corresponds to a word embedding 322 of the word “A”, and a word feature 334 corresponds to a word embedding 324 of the word “stop”.

To reconstruct the masked source pixel blocks, in the process 300 a technique such as a transformer may be used to generate a mask image feature for the masking pixel block, then the mask image feature is inserted back to a corresponding position in the multi-modal feature 312, thereby generating an updated multi-modal feature 314 (also referred to as a second multi-modal feature). For example, in the process 300 a mask image feature 318 may be generated based on the masking pixel block. In some embodiments, since the same mask pixel block is used to mask several source pixel blocks, the mask image feature may be generated only once and inserted at each corresponding position in the multi-modal feature 312. For example, in the process 300 the mask image feature 318 is inserted between the image feature 316 and the image feature 320 to represent the mask image features of the pixel block 108.

After the updated multi-modal feature 314 is generated, in the process 300 the decoder 126 may be used to decode the image feature portion of the updated multi-modal feature 314 to generate target pixel blocks 108′, 112′, 114′, and 116′, wherein the target pixel block 108′ is a reconstruction of the masked source pixel block 108 based on the image feature portion of the multi-modal feature 314, the target pixel block 112′ is a reconstruction of the masked source pixel block 112, the target pixel block 114′ is a reconstruction of the masked source pixel block 114, and the target pixel block 116′ is a reconstruction of the masked source pixel block 116. In the process 300, it is desirable to allow the content in the generated target pixel block approximate to the content in the original source pixel block by optimizing various parameters of the multi-modal model 124. For example, the stop sign is not present in all pixel blocks in the reversed pixel block sequence 302; however, according to the knowledge provided by the embedding of word sequence 308, the stop sign should appear in the original image, so it is desirable that the stop sign appear in the generated target pixel block. Thus, in the process 300 a current loss is calculated by constructing a loss function by determining a mean square error between the reconstructed target pixel block and the original source pixel block. Then, in the process 300 the loss may be back-propagated to the multi-modal model 124 to optimize various parameters in the multi-modal model 124. When the loss is less than a certain threshold, the training of the multi-modal model 124 may be completed.

In the embodiment shown in FIG. 3, it is possible to, by removing the masked source pixel block from the source pixel block sequence, reduce the effective area in the image that the multi-modal model needs to process, and thereby reduce the amount of computation and the consumption of computing resources, and reduce the requirements for the computing capability. In addition, the existing training data may be efficiently used by randomly masking different pixel blocks in the same image, so that the multi-modal model can be trained with less training data, and the training cost is reduced.

In some embodiments, to further improve the training efficiency of the multi-modal model, and to improve the accuracy of the multi-modal model, a word (also referred to as a source word) in the text may be masked, and then a target word corresponding to the masked word is generated based on the source image and the masked word sequence. In these embodiments, a loss function may be constructed based on a differences between the target word and the source word, and an overall loss function of the multi-modal model may be constructed based on both the loss function constructed during the training by masking the image and the loss function constructed during the training by masking the text, and then the various parameters of the multi-modal model may be optimized such that the value of the overall loss function is minimized.

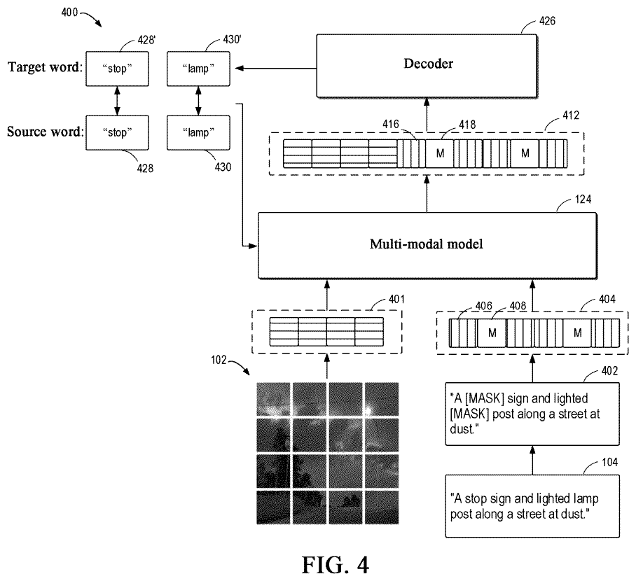

FIG. 4 illustrates a schematic diagram of a process 400 for training a multi-modal model by masking a text, according to some embodiments of the disclosure. As shown in FIG. 4, in the process 400 an image 102 is divided into a set of pixel blocks, and an embedding of pixel block sequence 401 is generated based on the sequence of these pixel blocks. On the other hand, in the process 400 a predetermined mask word (e.g., represented by [MASK] in FIG. 4) is used to randomly mask several words (e.g., “stop” and “lamp”) in the text 104 to generate a masked text 402. In the process 400, the masked text 402 may be converted to a form of a word sequence for subsequent operations. In the example shown in FIG. 4, in the process 400 a technique such as a transformer may be used to generate a corresponding word embedding for each word in the converted word sequence. For example, the word embedding 406 is an embedding representation of word “A”, and a word embedding 408 is an embedding representation of a mask word immediately following word “A”. An embedding of word sequence 404 is an ordered embedding sequence consisting of all such word embeddings. The embedding of word sequence 404 includes 12 word embeddings corresponding to 12 words (including several mask words) in the masked text 402. However, only 6 word embeddings are shown in FIG. 4 for the sake of brevity.

As shown in FIG. 4, in the process 400 the embedding of pixel block sequence 401 and the word embedding sequence 404 are input into multi-modal model 124, so that the multi-modal model can learn knowledge and features shared between the pixel block embedding and word embedding, and then a multi-modal feature 412 (also referred to as a third multi-modal feature) is output. In the example shown in FIG. 4, the multi-modal feature 312 comprises an image feature portion and a text feature portion. The image feature portion comprises 16 pixel block features corresponding to 16 pixel block embeddings in the embedding of pixel block sequence 401. The text feature portion comprises 12 word features, which correspond to 12 word embeddings in the embedding of word sequence 404. For example, a word feature 416 corresponds to a word embedding 406 of the word “A”, and a word feature 408 corresponds to a mask word of the word “stop”.

After the multi-modal feature 412 is generated, in the process 400 a decoder 426 may be used to decode a portion in the multi-modal feature 412 where the text feature is masked (namely, a portion in the multi-modal feature 412 except for the image feature portion and a portion where the text feature is not masked) to thereby generate target words 428′ and 430′, wherein the target word 428′ is a reconstruction of a masked source word 428 based on the portion of the multi-modal feature 412 where the text feature is masked, and the target word 430′ is a reconstruction of the masked source word 430. In the process 400 a loss function (also referred to as a second loss function) may be constructed using a cross entropy function based on the reconstructed target words and the original source words, thereby calculating the current loss. In some embodiments, during the training phase of multi-modal model 124, the process 300 of masking the image as shown in FIG. 3 may be performed in parallel in process 400, thereby constructing a loss function of masking the images and a loss function of masking the text. The process 400 may construct an overall loss function (also referred to as a third loss function) by summing the two loss functions, and a goal of the process 400 is to minimize the value of the overall loss function by optimizing various parameters of the multi-modal model 124.

By performing the training process of masking the image and the training process of masking the text simultaneously, the multi-modal model may learn richer, deeper knowledge and features, which helps the model to better understand and interpret complex real-world things. In addition, this training manner enables the multi-modal model to better learn how to align and correlate the image and text information with each other, thereby improving the alignment capability of the model and exhibiting greater robustness in processing noise data in the various modalities. In addition, the training manner is helpful for accelerating the convergence speed of the model and improving the training efficiency. Compared with some traditional schemes, the training manner only needs to train the multi-modal model without depending on other models, thereby improving the stability of the training process and the accuracy of the multi-modal model.

The structure of the multi-modal model may be optimized in order to further improve the training effect of the multi-modal model. The multi-modal model may receive an embedding of pixel block sequence and an embedding of word sequence as input and then output a multi-modal feature. In some embodiments, in the structure of the multi-modal model, an image feature and a text feature may be generated using a shared self-attention network and based on the embedding of pixel block sequence and the embedding of word sequence input into the model. Then, the image feature and text feature are further optimized using an image-specific network and a text-specific network, respectively. Then, the image feature and text feature are further optimized using another shared self-attention network based on the image feature and text feature. The multi-modal feature is then output using a multi-layer routing network comprised of a plurality of networks.

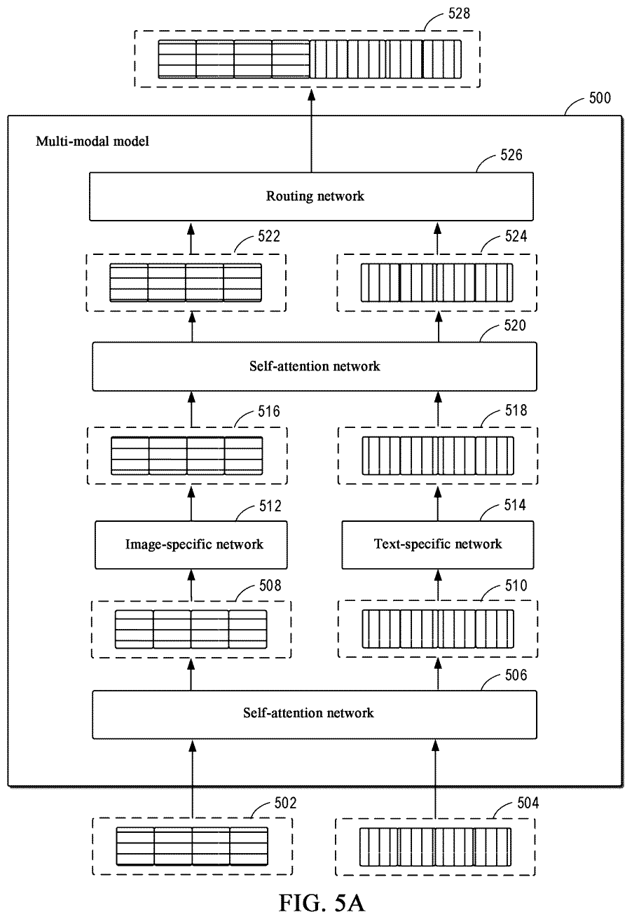

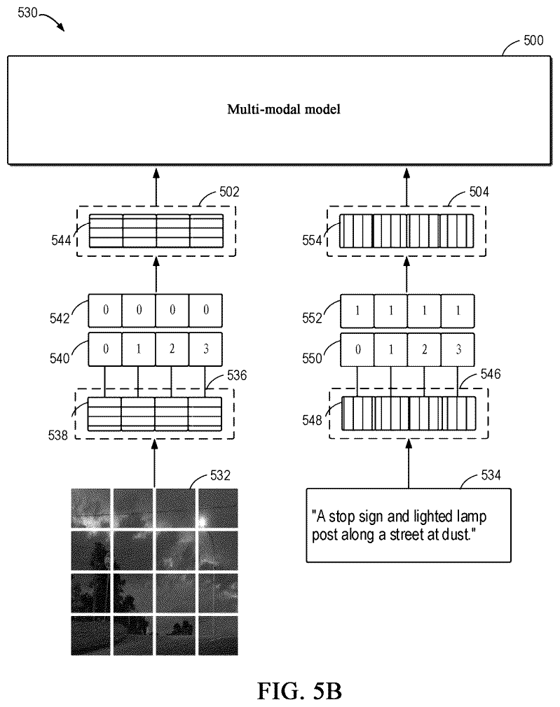

FIG. 5A illustrates a schematic diagram of the structure of a multi-modal model 500 according to some embodiments of the present disclosure. As shown in FIG. 5A, the multi-modal model 500 receives an embedding of pixel block sequence 502 and an embedding of word sequence 504 as an input and outputs a multi-modal feature 530. FIG. 5B illustrates a schematic diagram of a process 530 of generating an embedding of pixel block sequence 502 and an embedding of word sequence 504 according to some embodiments of the present disclosure. In the process 530, an image 532 is divided into a set of pixel blocks, and in the process 530 an embedding of pixel block sequence 536 is generated based on the divided image 532. Then, in the process 530, an embedding corresponding to each pixel block in the embedding of pixel block sequence 536 is added up with a position embedding of the pixel block and a modal embedding representing an image modality so that the multi-modal model 500 may capture the position and modality information of each pixel block embedding. For example, in the process 530 a pixel block embedding 538 is added up with a position embedding 540 that represents its position in the pixel block sequence (e.g., a position of a first pixel block in the pixel block sequence is represented by “0”, a position of a second pixel block is represented by “1”, and so on) and a modality embedding 542 that represents its modality type (e.g., an image modality is represented by “0” and a text modality is represented by “1”), thereby generating a pixel block embedding 544. The embedding of pixel block sequence 502 may be generated by performing the above-described operations for all the pixel block embeddings in the embedding of pixel block sequence 536. Similarly, in the process 530 an embedding of word sequence 546 is generated based on a text 534. Then, in the process 530 the embedding corresponding to each word in the embedding of word sequence 546 may be added up with the positioning embedding of the word and the modality embedding representing the text modality, so that the multi-modal model 500 may capture the position and modality information of each word embedding. For example, in the process 530 a word embedding 548 may be added up with a position embedding 550 representing its position in the text and a modality embedding 552 representing its modality type, thereby generating the word embedding 554. The embedding of word sequence 504 may be generated by performing the above operations on all word embeddings in the embedding of word sequence 546.

In the example shown in FIG. 5A, the multi-modal model 500 comprises a self-attention network 506 (also referred to as a first self-attention network), an image-specific network 512, a text-specific network 514, a self-attention network 520 (also referred to as a second self-attention network), and a routing network 526. The self-attention network 520 receives the embedding of pixel block sequence 502 and the embedding of word sequence 504 as an input and outputs an image feature 508 (also referred to as a first image intermediate feature) and a text feature 510 (also referred to as a first text intermediate feature). Here, the pixel block embedding and the text embedding are processed by the same self-attention network 506, so that parameters of the self-attention network 506 may be shared when the pixel block embedding 502 and the text embedding 504 are processed, which helps to better capture and fuse shared features and associated information between the image modality and the text modality. Additionally, the use of the self-attention network may help to improve the effect and performance of the multi-modal model 500 in extracting features from the pixel block embedding and the text embedding.

As shown in FIG. 5A, the multi-modal model 500 employs the image-specific network 512 to process the image feature 508 to generate an image feature 516 (also referred to as a second image intermediate feature) and employs the text-specific network 514 to process the text feature 510 to generate a text feature 518 (also referred to as second text intermediate features). Here, the image feature 508 and the text feature 510 are processed respectively by a dedicated network dedicated to each modality according to different modalities. Therefore, a dedicated network structure may be respectively designed according to respective characteristics of the image and the text, so that the characteristics of the image and the text can be captured better, and the accuracy and the effect of extracting the characteristics are improved. In addition, this approach also allows the respective dedicated networks to be optimized respectively for both modalities without worrying about having a significant impact on the other modality, thereby making the respective optimization and improvement more flexible.

As shown in FIG. 5A, the multi-modal model 500 employs another shared self-attention network 520 to process the image feature 516 and text feature 518 to generate an image feature 522 (also referred to as a third image intermediate feature) and a text feature 524 (also referred to as a third text intermediate feature). Here the shared self-attention network is used again to process features of different modalities so that the parameters of the self-attention network 520 may be shared when the image feature 516 and the text feature 518 are processed. By the method, the image feature and the text features may be further fused, so that the association between the image feature and the text feature is enhanced, and the cross-modal learning is promoted. As shown in FIG. 5A, the multi-modal model 500 employs a routing network 526 to process the image feature 522 and the text feature 524 to generate a multi-modal feature 528.

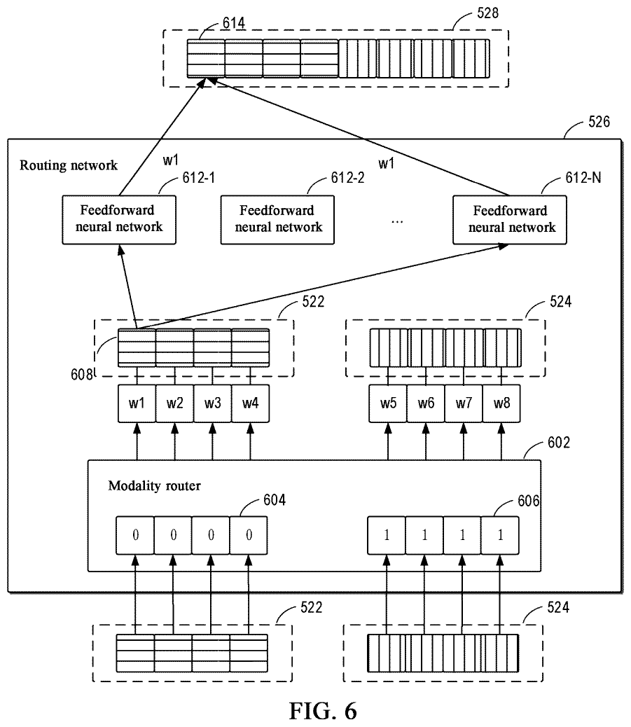

FIG. 6 illustrates a schematic diagram of the structure of the routing network 526 according to some embodiments of the present disclosure. As shown in FIG. 6, the routing network 526 receives the image feature 522 and the text feature 524 as an input and outputs the multi-modal feature 528, the multi-modal feature 528 including an image feature portion and a text feature portion. The routing network 526 comprises a modality router 602 and a plurality of feedforward neural networks 612-1, 612-2, . . . , 612-N (collectively referred to as 612 herein). At the modality router 602, the routing network 526 adds each pixel block feature in the image feature 522 corresponding to a pixel block up with a modality embedding (e.g., a modality embedding 604 represented by 0 in FIG. 6) representing an image modality, to generate an adjusted image feature 522. Similarly, at the modality router 602, the routing network 526 adds each word feature in the text feature 524 corresponding to a word up with a modality embedding (e.g., a modality embedding 606 represented by 1 in FIG. 6) representing a text modality, to generate an adjusted text feature 524. The modality router 602 then generates a respective weight vector, e.g., w1 through w8 in FIG. 6, for each pixel block feature in the image feature 522 and each word feature in the text feature 524 based on the adjusted image feature 522 and the adjusted text feature 524. After generating the weight vectors w1-w8, the routing network 526 may assign a portion of the feedforward neural networks 612 to each pixel block feature in the image feature 522 and each word feature in the text feature 524 to process these features, and the weight vectors include the weight of each feedforward neural network 12 for a given pixel block feature or word feature.

In some embodiments, a given feature may be input to the feedforward neural network 612 where all weights in the corresponding weight vectors are non-zero values. In other embodiments, a given feature may be input to a predetermined number of feedforward neural networks 612 with the highest weights in the corresponding weight vectors. For example, in the example shown in FIG. 6, a pixel block feature 608 corresponds to the weight vector w1, the routing network may input the pixel block feature 608 to two feedforward neural networks 612 (i.e., feedforward neural networks 612-1 and 612-N) with the highest weight in the weight vector w1. The routing network 526 then generates a pixel block feature 614 in the multi-modal feature 528 based on the outputs of the feedforward neural networks 612-1 and 612-N and the weight values of the two feedforward neural networks in the weight vector w1. In some embodiments, the weights of the feedforward neural networks 612-1 and 612-N may be recalculated according to their proportions in the weight vector w1 such that the sum of the recalculated weights is equal to 1. The outputs of the feedforward neural networks 612-1 and 612-N are then multiplied by the corresponding recalculated weights, respectively, and the results of the calculation are summed to generate a pixel block feature 614.

In this way, the feedforward neural network 612 may be used for both a single-modality dedicated network and a multi-modality fusion network, and the routing network 526 may automatically route a pixel block feature or a word feature to a proper network, thereby improving the accuracy of the multi-modal model. In addition, because different features of the same modality and different features of different modalities may both be input into the same feedforward neural network 612, parameters of the network may be shared between the same modalities or between different modalities, thereby facilitating enhancing knowledge sharing between inputs of the same modalities (e.g., between different pixel block features in the image feature 522 or between different word features in the text feature 524) and knowledge sharing between inputs of different modalities (e.g., between the pixel block feature in image feature 522 and the word feature in the text feature 524), thereby enabling the improvement of the accuracy of the multi-modal model 500.

In some embodiments, several sets of structures consisting of the shared self-attention network, the image-specific network and the text-specific network may be added again over the image-specific network 512 and text-specific network 514 on the basis of model 500 shown in FIG. 5. For example, where a total number of layers of the multi-modal model 500 is N layers, the N-to-L layers in a lower portion may include multiple sets of shared self-attention networks, image-specific networks, and text-specific networks. In some embodiments, several sets of structures consisting of the shared self-attention network and routing network may be added again over the routing network 526. For example, where a total number of layers of the multi-modal model 500 is N layers, the L layers at the top may include multiple sets of shared self-attention networks and routing networks. By stacking two types of network structures multiple times, the multi-modal model 500 may be enabled to learn more advanced features, thereby improving the accuracy and generalization capability of the model.

In some embodiments, multiple sets of structures consisting of shared self-attention networks, image-specific network and text-specific networks may be added again over image-specific network 512 and text-specific network 514 based on the model 500 shown in FIG. 5. For example, where the total number of layers of the multi-modal model 500 is N layers, the N-to-L layers in the lower portion may include multiple sets of shared self-attention networks, image-specific networks and text-specific networks. By stacking such a structure multiple times, the multi-modal model 500 may be enabled to learn more advanced features, thereby improving the accuracy and generalization capability of the model.

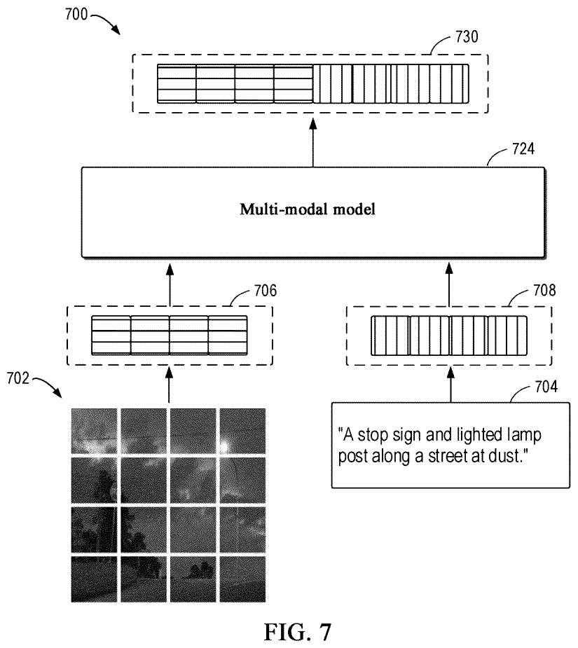

In an inference phase, the multi-modal model generates multi-modal features for use by downstream tasks based on the input image and text. FIG. 7 illustrates a schematic diagram of a process 700 for using a multi-modal model in an inference phase according to some embodiments of the disclosure. As shown in FIG. 7, a multi-modal model 724 (which may be, for example, the multi-modal model 124 of FIG. 1) may generate a multi-modal feature 730 based on an image 702 and a text 704, the multi-modal feature 730 including an image feature portion and a text feature portion. In the process 700, the image 702 is divided into a set of pixel blocks, an embedding of pixel block sequence 706 is generated based on the pixel blocks, and the embedding of pixel block sequence 706 comprises a pixel block embedding corresponding to each pixel block in the image 702. In addition, in the process 700 an embedding of word sequence 708 is generated based on the text 704, the embedding of word sequence 708 comprising a word embedding corresponding to each word in the text 704. In the process 700 the embedding of pixel block sequence 706 and the embedding of word sequence 708 are input into the multi-modal model 724, and then the multi-modal model 724 outputs a multi-modal feature 730 that is available to a downstream task.

The downstream task may add a self-defined task header on the basis of the multi-modal model 724, the task header is a classification layer, a regression layer, or other output layer suitable for a specific task, and the task header will be responsible for mapping the multi-modal feature 730 to an output associated with the specific task. The downstream task may choose a suitable learning rate, optimizer, and loss function to fine tune the model to allow the model to better adapt to new tasks while retaining knowledge that the multi-modal model 724 has learned.

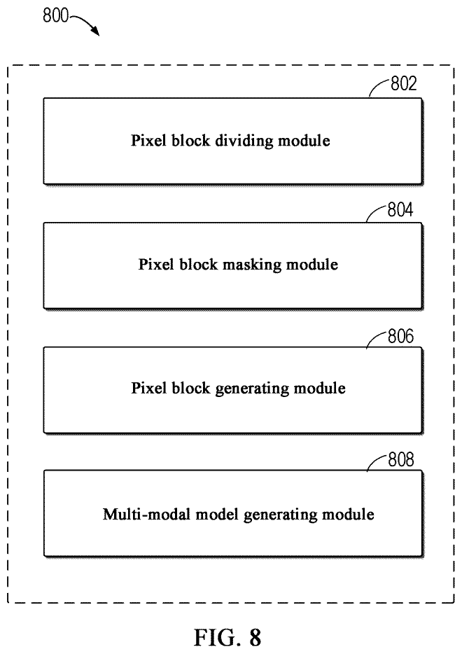

FIG. 8 illustrates a block diagram of an apparatus 800 for processing multi-modal data according to some embodiments of the present disclosure. As shown in FIG. 8, the apparatus 800 comprises a pixel block dividing module 802 configured to divide a source image into a set of source pixel blocks, each pixel block in the set of source pixel blocks including a plurality of pixels. The apparatus 800 further comprises a pixel block masking module 804 configured to generate a masked source pixel block sequence by masking one or more source pixel blocks in the set of source pixel blocks. In addition, the apparatus 800 comprises a pixel block generating module 806 configured to generate one or more target pixel blocks corresponding to the one or more source pixel blocks based on the masked source pixel block sequence and a source text corresponding to the source image. In addition, the apparatus 800 further comprises a multi-modal model generating module 808 configured to generate a multi-modal model based on the one or more source pixel blocks and the one or more target pixel blocks.

It will be appreciated that at least one of the many advantages that can be achieved by the methods or processes described above may be achieved by the apparatus 800 according to the present disclosure. For example, it is possible to, by masking different pixel blocks in the same image, efficiently use existing training data so that less training data can be used to train the multi-modal model, thereby reducing the training cost. In addition, this scheme avoids training additional visual tokenizers by comparing the pixel blocks to obtain a difference, thereby reducing the complexity of training the multi-modal model and improving the stability and accuracy of the model.

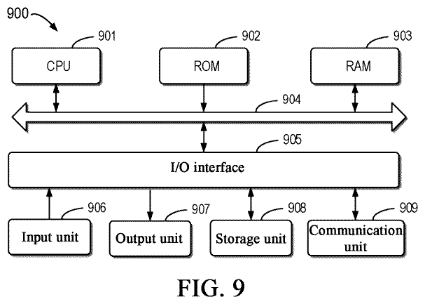

FIG. 9 shows a block diagram of an electronic device 900 according to some embodiments of the present disclosure. The device 900 may be a device or apparatus described in embodiments of the present disclosure. As shown in FIG. 9, the device 900 comprises a Central Processing Unit (CPU) and/or a Graphics Processing Unit (GPU) 901, which may perform various suitable actions and processes in accordance with computer program instructions stored in a Read-Only Memory (ROM) 902 or loaded from a storage unit 908 into a Random Access Memory (RAM) 903. In the RAM 903, various programs and data needed by the device 900 in operations may also be stored. The CPU/GPU 901, ROM 902 and RAM 903 are connected to one another via a bus 904. An input/output (I/O) interface 905 is also connected to the bus 904. Although not shown in FIG. 9, the device 900 may further include a coprocessor.

Various components in the device 900 are connected to an I/O interface 905, including: an input unit 906 such as a keyboard, a mouse, or the like; an output unit 907 such as various types of displays, speakers, and the like; a storage unit 908 such as a magnetic disk, an optical disk, or the like; and a communication unit 909 such as a network card, a modem, a wireless communication transceiver, or the like. The communication unit 909 allows the device 900 to exchange information/data with other devices through a computer network such as the Internet and/or various telecommunications networks.

The various methods or processes described above may be performed by the CPU/GPU 901. For example, in some embodiments, the method may be implemented as a computer software program tangibly embodied on a non-transitory machine-readable medium, such as the storage unit 908. In some embodiments, part or all of the computer program may be loaded into and/or installed onto the device 900 via the ROM 902 and/or the communication unit 909. When the computer program is loaded into RAM 903 and executed by CPU/GPU 901, one or more steps or actions in the above-described methods or processes may be performed.

In some embodiments, the methods and processes described above may be implemented as a computer program product. The computer program product may include a non-transitory computer readable storage medium having computer readable program instructions embodied thereon for performing aspects of the present disclosure.

The non-transitory computer readable storage medium may be a tangible device that may hold and store instructions for use by an instruction execution device. The computer readable storage medium may be, for example, but not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium would include the following: a portable computer disk, a hard disk, a Random Access Memory (RAM), a Read-Only Memory (ROM), an Erasable Programmable Read-Only Memory (EPROM or flash memory), a Static Random Access Memory (SRAM), a Portable Compact Disk Read-Only Memory (CD-ROM), a Digital Versatile Disks (DVD), a memory stick, a floppy disk, a mechanically encoded device such as punch-cards or raised structures in a groove having instructions recorded thereon, and any suitable combination of the foregoing. The computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language and procedural programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

These computer readable program instructions can be provided to a processor of a general purpose computer, special purpose computer, or other programmable data processing apparatus to produce a machine, such that the instructions, which execute via the processor of the computer or other programmable data processing apparatus, create method for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored thereon comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some example implementations of the present disclosure are listed below:

Example 1. A method for processing multi-modal data, comprising:
dividing a source image into a set of source pixel blocks, each pixel block in the set of source pixel blocks comprising a plurality of pixels;
generating a masked source pixel block sequence by masking one or more source pixel blocks of the set of source pixel blocks;
generating one or more target pixel blocks corresponding to the one or more source pixel blocks based on the masked source pixel block sequence and a source text corresponding to the source image; and
generating a multi-modal model based on the one or more source pixel blocks and the one or more target pixel blocks.

Example 2. The method according to Example 1, wherein generating the multi-modal model comprises:
generating a masked source word sequence by masking one or more source words in the source text;
generating one or more target words corresponding to the one or more source words based on the masked source word sequence and the source image; and
generating the multi-modal model based on the one or more source pixel blocks, the one or more target pixel blocks, the one or more source words and the one or more target words.

Example 3. The method according to Example 1, wherein generating the one or more target pixel blocks corresponding to the one or more source pixel blocks comprises:
generating a reserved pixel block sequence by removing the one or more masked source pixel blocks from the masked source pixel block sequence;
generating an embedding of reserved pixel block sequence based on the reserved pixel block sequence;
generating an embedding of source word sequence based on the source text; and
generating a first multi-modal feature based on the embedding of reserved pixel block sequence and the embedding of source word sequence.

Example 4. The method according to Example 3, wherein generating the one or more target pixel blocks corresponding to the one or more source pixel blocks further comprises:
generating one or more masked pixel block features based on the one or more masked source pixel blocks;
generating a second multi-modal feature by inserting the one or more masked pixel block features to respective position in the first multi-modal feature; and
generating the one or more target pixel blocks by using an image decoder based on the second multi-modal feature.

Example 5. The method according to Example 2, wherein generating the one or more target words corresponding to the one or more source words comprises:
generating an embedding of source pixel block based on the source image;
generating an embedding of masked word sequence based on the masked source word sequence;
generating a third multi-modal feature based on the embedding of source pixel block and the embedding of masked word sequence; and
generating the one or more target words based on the third multi-modal feature.

Example 6. The method according to Example 2, wherein generating the multi-modal model further comprises:
generating a first loss function by determining a mean square error between the one or more source pixel blocks and the one or more target pixel blocks;
generating a second loss function by using a cross entropy function based on the one or more source words and the one or more target words;
generating a third loss function based on the first loss function and the second loss function; and
generating the multi-modal model by using the third loss function.

Example 7. The method according to Example 3, wherein generating the first multi-modal feature comprises:
generating a first image intermediate feature and a first text intermediate feature by using a first self-attention network based on the embedding of reserved pixel block sequence and the embedding of source word sequence.

Example 8. the method according to Example 7, wherein generating the first multi-modal feature further comprises:
generating a second image intermediate feature by using an image-specific network based on the first image intermediate feature; and
generating a second text intermediation feature by using a text-specific network based on the first text intermediation feature.

Example 9. The method according to Example 8, wherein generating the first multi-modal feature further comprises:
generating a third image intermediate feature and a third text intermediate feature by using a second self-attention network based on the second image intermediate feature and the second text intermediate feature.

Example 10. The method according to Example 9, wherein generating the first multi-modal feature further comprises:
generating the first multi-modal feature by using a routing network based on the third image intermediate feature and the third text intermediate feature, wherein the routing network comprises a plurality of feedforward neural networks.

Example 11. The method according to Example 10, wherein generating the first multi-modal feature further comprises:
generating a plurality of weight vectors of feedforward neural network by using the routing network based on the third image intermediate feature and the third text intermediate feature; and
generating the first multi-modal feature based on the third image intermediate feature, the third text intermediate feature and the plurality of weight vectors of feedforward neural network.

Example 12. The method according to Example 1, further comprising:
obtaining an application image and an application text;
dividing the application image into a set of pixel blocks;
generating a pixel block sequence feature and a word sequence feature based on the set of pixel blocks and the application text; and
generating a multi-modal feature by using the multi-modal model based on the pixel block sequence feature and the word sequence feature.

Example 13. An apparatus for processing multi-modal data, comprising:
a pixel block dividing module configured to divide a source image into a set of source pixel blocks, each pixel block in the set of source pixel blocks comprising a plurality of pixels;
a pixel block masking module configured to mask one or more source pixel blocks of the set of source pixel blocks to generate a masked source pixel block sequence;
a pixel block generating module configured to generate one or more target pixel blocks corresponding to the one or more source pixel blocks based on the masked source pixel block sequence and a source text corresponding to the source image; and
a multi-modal model generating module configured to generate a multi-modal model based on the one or more source pixel blocks and the one or more target pixel blocks.

Example 14. The apparatus according to Example 13, wherein generating the multi-modal model comprises:
a word sequence masking module configured to generate a masked source word sequence by masking one or more source words in the source text;
a target word generating module configured to generate one or more target words corresponding to the one or more source words based on the masked source word sequence and the source image; and
a second model generating module configured to generate the multi-modal model based on the one or more source pixel blocks, the one or more target pixel blocks, the one or more source words, and the one or more target words.

Example 15. The apparatus according to Example 13, wherein generating the one or more target pixel blocks corresponding to the one or more source pixel blocks comprises:
a masked pixel block removing module configured to generate a reserved pixel block sequence by removing the one or more masked source pixel blocks from the masked source pixel block sequence;
a pixel block embedding generating module configured to generate an embedding of reserved pixel block sequence based on the reserved pixel block sequence;
an embedding of word sequence generating module configured to generate an embedding of source word sequence based on the source text; and
a first multi-modal feature generating module configured to generate a first multi-modal feature based on the embedding of reserved pixel block sequence and the embedding of source word sequence.

Example 16. The apparatus according to Example 15, wherein generating the one or more target pixel blocks corresponding to the one or more source pixel blocks further comprises:
a masked pixel block feature generating module configured to generate one or more masked pixel block features based on the one or more masked source pixel blocks;
a second multi-modal feature generating module configured to generate a second multi-modal feature by inserting the one or more masked pixel block features to respective position in the first multi-modal feature;
a target pixel block generating module configured to generate the one or more target pixel blocks by using an image decoder based on the second multi-modal feature.

Example 17. The apparatus according to Example 14, wherein generating the one or more target words corresponding to the one or more source words comprises:
a pixel block embedding generating module configured to generate an embedding of source pixel block based on the source image;
a masked word embedding generating module configured to generate an embedding of masked word sequence based on the masked source word sequence;
a third multi-modal feature generating module configured to generate a third multi-modal feature based on the embedding of source pixel block and the mask word sequence embedding; and
a target word generating module configured to generate the one or more target words based on the third multi-modal feature.

Example 18. The apparatus according to Example 14, wherein generating the multi-modal model further comprises:
a first loss function generating module configured to generate a first loss function by determining a mean square error between the one or more source pixel blocks and the one or more target pixel blocks;
a second loss function generating module configured to generate a second loss function using a cross entropy function based on the one or more source words and the one or more target words;
a third loss function generating module configured to generate a third loss function based on the first loss function and the second loss function; and
a third loss function using module configured to generate the multi-modal model using the third loss function.

Example 19. The apparatus according to Example 15, wherein generating the first multi-modal feature comprises:
a first intermediate feature generating module configured to generate a first image intermediate feature and a first text intermediate feature using a first self-attention network based on the embedding of reserved pixel block sequence and the embedding of source word sequence.

Example 20. The apparatus according to Example 19, wherein generating the first multi-modal feature further comprises:
a second image feature generating module configured to generate a second image intermediate feature using an image-specific network based on the first image intermediate feature; and
a second text feature generating module configured to generate a second text intermediation feature using a text-specific network based on the first text intermediation feature.

Example 21. The apparatus according to Example 20, wherein generating the first multi-modal feature further comprises:
a third immediate feature generating module configured to generate a third image intermediate feature and a third text intermediate feature using a second self-attention network based on the second image intermediate feature and the second text intermediate feature.

Example 22. The apparatus according to Example 21, wherein generating the first multi-modal feature further comprises:
a first multi-modal feature generating module configured to generate the first multi-modal feature using a routing network based on the third image intermediate feature and the third text intermediate feature, wherein the routing network comprises a plurality of feedforward neural networks.

Example 23. The apparatus according to Example 22, wherein generating the first multi-modal feature further comprises:
a weight vector generating module configured to generate a plurality of weight vectors of feedforward neural network using the routing network based on the third image intermediate feature and the third text intermediate feature; and
a weight vector using module configured to generate the first multi-modal feature based on the third image intermediate feature, the third text intermediate feature, and the plurality of weight vectors of feedforward neural network.

Example 24. The apparatus according to Example 13, further comprising:
a data obtaining module configured to obtain an application image and an application text;
an image dividing module configured to divide the application image into a set of pixel blocks;
an embedding generating module configured to generate a pixel block sequence feature and a word sequence feature based on the set of pixel blocks and the application text; and
a feature generating module configured to generate a multi-modal feature using the multi-modal model based on the pixel block sequence feature and the word sequence feature.

Example 25. An electronic device, comprising:
a processor; and
a memory coupled with the processor, the memory having instructions stored thereon, which when executed by the processor, cause the electronic device to perform acts comprising:
dividing a source image into a set of source pixel blocks, each pixel block in the set of source pixel blocks comprising a plurality of pixels;
generating a masked source pixel block sequence by masking one or more source pixel blocks of the set of source pixel blocks;
generating one or more target pixel blocks corresponding to the one or more source pixel blocks based on the masked source pixel block sequence and a source text corresponding to the source image; and
generating a multi-modal model based on the one or more source pixel blocks and the one or more target pixel blocks.

Example 26. The electronic device according to Example 25, wherein generating the multi-modal model comprises:
generating a masked source word sequence by masking one or more source words in the source text;
generating one or more target words corresponding to the one or more source words based on the masked source word sequence and the source image; and
generating the multi-modal model based on the one or more source pixel blocks, the one or more target pixel blocks, the one or more source words and the one or more target words.

Example 27. The electronic device according to Example 25, wherein generating the one or more target pixel blocks corresponding to the one or more source pixel blocks comprises:
generating a reserved pixel block sequence by removing the one or more masked source pixel blocks from the masked source pixel block sequence;
generating an embedding of reserved pixel block sequence based on the reserved pixel block sequence;
generating an embedding of source word sequence based on the source text; and
generating a first multi-modal feature based on the embedding of reserved pixel block sequence and the embedding of source word sequence.

Example 28. The electronic device according to Example 27, wherein generating the one or more target pixel blocks corresponding to the one or more source pixel blocks further comprises:
generating one or more masked pixel block features based on the one or more masked source pixel blocks;
generating a second multi-modal feature by inserting the one or more masked pixel block features to respective position in the first multi-modal feature; and
generating the one or more target pixel blocks by using an image decoder based on the second multi-modal feature.

Example 29. The electronic device according to Example 26, wherein generating the one or more target words corresponding to the one or more source words comprises:
generating an embedding of source pixel block based on the source image;
generating an embedding of masked word sequence based on the masked source word sequence;
generating a third multi-modal feature based on the embedding of source pixel block and the embedding of masked word sequence; and
generating the one or more target words based on the third multi-modal feature.

Example 30. The electronic device according to Example 26, wherein generating the multi-modal model further comprises:
generating a first loss function by determining a mean square error between the one or more source pixel blocks and the one or more target pixel blocks;
generating a second loss function by using a cross entropy function based on the one or more source words and the one or more target words;
generating a third loss function based on the first loss function and the second loss function; and
generating the multi-modal model by using the third loss function.

Example 31. The electronic device according to Example 27, wherein generating the first multi-modal feature comprises:
generating a first image intermediate feature and a first text intermediate feature by using a first self-attention network based on the embedding of reserved pixel block sequence and the embedding of source word sequence.

Example 32. The electronic device according to Example 31, wherein generating the first multi-modal feature further comprises:
generating a second image intermediate feature by using an image-specific network based on the first image intermediate feature; and
generating a second text intermediation feature by using a text-specific network based on the first text intermediation feature.

Example 33. The electronic device according to Example 32, wherein generating the first multi-modal feature further comprises:
generating a third image intermediate feature and a third text intermediate feature by using a second self-attention network based on the second image intermediate feature and the second text intermediate feature.

Example 34. The electronic device according to Example 33, wherein generating the first multi-modal feature further comprises:
generating the first multi-modal feature by using a routing network based on the third image intermediate feature and the third text intermediate feature, wherein the routing network comprises a plurality of feedforward neural networks.

Example 35. The electronic device according to Example 34, wherein generating the first multi-modal feature further comprises:
generating a plurality of weight vectors of feedforward neural network by using the routing network based on the third image intermediate feature and the third text intermediate feature; and
generating the first multi-modal feature based on the third image intermediate feature, the third text intermediate feature and the plurality of weight vectors of feedforward neural network.

Example 36. The electronic device according to Example 25, further comprising:
obtaining an application image and an application text;
dividing the application image into a set of pixel blocks;
generating a pixel block sequence feature and a word sequence feature based on the set of pixel blocks and the application text; and
generating a multi-modal feature by using the multi-modal model based on the pixel block sequence feature and the word sequence feature.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

I/We claim:

1. A method for processing multi-modal data, comprising:
dividing a source image into a set of source pixel blocks, each pixel block in the set of source pixel blocks comprising a plurality of pixels;
generating a masked source pixel block sequence by masking one or more source pixel blocks of the set of source pixel blocks;
generating one or more target pixel blocks corresponding to the one or more source pixel blocks based on the masked source pixel block sequence and a source text corresponding to the source image; and
generating a multi-modal model based on the one or more source pixel blocks and the one or more target pixel blocks.

2. The method according to claim 1, wherein generating the multi-modal model comprises:
generating a masked source word sequence by masking one or more source words in the source text;
generating one or more target words corresponding to the one or more source words based on the masked source word sequence and the source image; and
generating the multi-modal model based on the one or more source pixel blocks, the one or more target pixel blocks, the one or more source words and the one or more target words.

3. The method according to claim 1, wherein generating the one or more target pixel blocks corresponding to the one or more source pixel blocks comprises:
generating a reserved pixel block sequence by removing the one or more masked source pixel blocks from the masked source pixel block sequence;
generating an embedding of reserved pixel block sequence based on the reserved pixel block sequence;
generating an embedding of source word sequence based on the source text; and
generating a first multi-modal feature based on the embedding of reserved pixel block sequence and the embedding of source word sequence.

4. The method according to claim 3, wherein generating the one or more target pixel blocks corresponding to the one or more source pixel blocks further comprises:
generating one or more masked pixel block features based on the one or more masked source pixel blocks;
generating a second multi-modal feature by inserting the one or more masked pixel block features to respective position in the first multi-modal feature; and
generating the one or more target pixel blocks by using an image decoder based on the second multi-modal feature.

5. The method according to claim 2, wherein generating the one or more target words corresponding to the one or more source words comprises:
generating an embedding of source pixel block based on the source image;
generating an embedding of masked word sequence based on the masked source word sequence;
generating a third multi-modal feature based on the embedding of source pixel block and the embedding of masked word sequence; and
generating the one or more target words based on the third multi-modal feature.

6. The method according to claim 2, wherein generating the multi-modal model further comprises:
generating a first loss function by determining a mean square error between the one or more source pixel blocks and the one or more target pixel blocks;
generating a second loss function by using a cross entropy function based on the one or more source words and the one or more target words;
generating a third loss function based on the first loss function and the second loss function; and
generating the multi-modal model by using the third loss function.

7. The method according to claim 3, wherein generating the first multi-modal feature comprises:
generating a first image intermediate feature and a first text intermediate feature by using a first self-attention network based on the embedding of reserved pixel block sequence and the embedding of source word sequence.

8. The method according to claim 7, wherein generating the first multi-modal feature further comprises:
generating a second image intermediate feature by using an image-specific network based on the first image intermediate feature; and
generating a second text intermediation feature by using a text-specific network based on the first text intermediation feature.

9. The method according to claim 8, wherein generating the first multi-modal feature further comprises:
generating a third image intermediate feature and a third text intermediate feature by using a second self-attention network based on the second image intermediate feature and the second text intermediate feature.

10. The method according to claim 9, wherein generating the first multi-modal feature further comprises:
generating the first multi-modal feature by using a routing network based on the third image intermediate feature and the third text intermediate feature, wherein the routing network comprises a plurality of feedforward neural networks.

11. The method according to claim 10, wherein generating the first multi-modal feature further comprises:
generating a plurality of weight vectors of feedforward neural network by using the routing network based on the third image intermediate feature and the third text intermediate feature; and
generating the first multi-modal feature based on the third image intermediate feature, the third text intermediate feature and the plurality of weight vectors of feedforward neural network.

12. The method according to claim 1, further comprising:
obtaining an application image and an application text;
dividing the application image into a set of pixel blocks;
generating a pixel block sequence feature and a word sequence feature based on the set of pixel blocks and the application text; and
generating a multi-modal feature by using the multi-modal model based on the pixel block sequence feature and the word sequence feature.

13. An electronic device, comprising:
a processor; and
a memory coupled with the processor, the memory having instructions stored thereon, the instructions, when executed by the processor, causing the electronic device to:
divide a source image into a set of source pixel blocks, each pixel block in the set of source pixel blocks comprising a plurality of pixels;
generate a masked source pixel block sequence by masking one or more source pixel blocks of the set of source pixel blocks;
generate one or more target pixel blocks corresponding to the one or more source pixel blocks based on the masked source pixel block sequence and a source text corresponding to the source image; and
generate a multi-modal model based on the one or more source pixel blocks and the one or more target pixel blocks.

14. The device according to claim 13, wherein the instructions causing the electronic device to generate the multi-modal model comprise instructions causing the electronic device to:
generate a masked source word sequence by masking one or more source words in the source text;
generate one or more target words corresponding to the one or more source words based on the masked source word sequence and the source image; and
generate the multi-modal model based on the one or more source pixel blocks, the one or more target pixel blocks, the one or more source words and the one or more target words.

15. The device according to claim 13, wherein the instructions causing the electronic device to generate the one or more target pixel blocks corresponding to the one or more source pixel blocks comprise instructions causing the electronic device to:
generate a reserved pixel block sequence by removing the one or more masked source pixel blocks from the masked source pixel block sequence;
generate an embedding of reserved pixel block sequence based on the reserved pixel block sequence;
generate an embedding of source word sequence based on the source text; and
generate a first multi-modal feature based on the embedding of reserved pixel block sequence and the embedding of source word sequence.

16. The device according to claim 15, wherein the instructions causing the electronic device to generate the one or more target pixel blocks corresponding to the one or more source pixel blocks further comprise instructions causing the electronic device to:
generate one or more masked pixel block features based on the one or more masked source pixel blocks;
generate a second multi-modal feature by inserting the one or more masked pixel block features to respective position in the first multi-modal feature; and
generate the one or more target pixel blocks by using an image decoder based on the second multi-modal feature.

17. The device according to claim 14, wherein the instructions causing the electronic device to generate the one or more target words corresponding to the one or more source words comprise instructions causing the electronic device to:
generate an embedding of source pixel block based on the source image;
generate an embedding of masked word sequence based on the masked source word sequence;
generate a third multi-modal feature based on the embedding of source pixel block and the embedding of masked word sequence; and
generate the one or more target words based on the third multi-modal feature.

18. The device according to claim 14, wherein the instructions causing the electronic device to generate the multi-modal model further comprise instructions causing the electronic device to:
generate a first loss function by determining a mean square error between the one or more source pixel blocks and the one or more target pixel blocks;
generate a second loss function by using a cross entropy function based on the one or more source words and the one or more target words;
generate a third loss function based on the first loss function and the second loss function; and
generate the multi-modal model by using the third loss function.

19. The device according to claim 15, wherein the instructions causing the electronic device to generate the first multi-modal feature comprise instructions causing the electronic device to:
generate a first image intermediate feature and a first text intermediate feature by using a first self-attention network based on the embedding of reserved pixel block sequence and the embedding of source word sequence.

20. The device according to claim 19, wherein the instructions causing the electronic device to generate the first multi-modal feature further comprise instructions causing the electronic device to:
generate a second image intermediate feature by using an image-specific network based on the first image intermediate feature; and
generate a second text intermediation feature by using a text-specific network based on the first text intermediation feature.

21. A non-transitory computer readable storage medium on which stores computer-executable instructions, wherein the compute-executable instructions are executed by a processor causing the processor to:
divide a source image into a set of source pixel blocks, each pixel block in the set of source pixel blocks comprising a plurality of pixels;
generate a masked source pixel block sequence by masking one or more source pixel blocks of the set of source pixel blocks;
generate one or more target pixel blocks corresponding to the one or more source pixel blocks based on the masked source pixel block sequence and a source text corresponding to the source image; and
generate a multi-modal model based on the one or more source pixel blocks and the one or more target pixel blocks.
